(19) United States
(12) Patent Application Publication
(10) Pub. No.: US 2022/0057525 A1
(43) Pub. Date: Feb. 24, 2022

(54) IDENTIFICATION DEVICE

(71) Applicant: Buddi Limited, Rickmansworth, Hertfordshire (GB)

(72) Inventors: Ewan FINDLAY, Campbell, CA (US); Sara MURRAY, Campbell, CA (US)

(21) Appl. No.: 17/310,211

(22) PCT Filed: Jan. 30, 2020
(86) PCT No.: PCT/GB2020/050226

§ 371 Date: Jul. 26, 2021

Related U.S. Application Data
(60) Provisional application No. 62/798,906, filed on Jan. 30, 2019.

(51) Int. Cl. G01S 19/14; G06K 9/00; H04W 4/38

(52) U.S. Cl. CPC G01S 19/14; H04W 4/38; G06K 9/00114

(57) ABSTRACT

A portable identification device comprises a biometric recognition system in combination with GPS or equivalent receivers for carrying out identification checks. The device is a basic portable unit.

### BACKGROUND

Currently law enforcement authorities use ankle bracelets (referred to as ‘tags’ or ‘ankle tags’) to track persons of interest (referred to as ‘users’). Alternatively, for lower risk users, a cell phone may be used. In this second case, the phone may be GPS enabled using an application installed by the authorities which cannot be altered in function by the user. The tag or phone is used to track the individual and in the case of the phone the user may be contacted at random to confirm their identity through facial recognition, either automatically or manually, or by automatic voice recognition.

Both the tag and phone systems are intended to give the authorities details of the user's location and confirm their identity/contact with the tag, with the intention of maintaining a record of their whereabouts and compliance with a legal order on the user's location and/or proximity to the phone/tag.

In circumstances where the tag is to be used on low risk users (for example, those not under a court supervision order associated with a criminal offence) it is deemed inhumane to apply an ankle-bracelet and, therefore, another means has been sought. The use of readily available cell phone technologies for this has been tried. However, cell phones have been found to have value and are easily cleared of content, reprogrammed and sold, which makes them potentially unreliable for the required purpose.

Additionally, facial and voice recognition comes with a degree of uncertainty in identifying individuals. In the case of facial recognition, this is particularly the case when the individual has control of the camera and its surroundings. In the case of voice recognition, there has to be a degree of uncertainty introduced because no person utters the same phrase in exactly the same way every time. Thus, certainty in identification is below that required in many cases where a cell phone is used.

In some cases, a cell phone with finger-print recognition may be used as a means of user-identification. The reliability of cell phone fingerprint recognition technology is regarded as poor at the time of writing and the application of more robust finger recognition techniques is seen as appropriate for security applications.

Note that in the case of fingerprint only a simple cast of the fingerprint, or more macabrely a removed finger, or finger section, can replace the finger and permit identification to the system through the mobile phone.

### SUMMARY

This disclosure relates to a device comprising a finger recognition system and which is capable of tracking its own location. Details of the device can be found in this disclosure.

According to a first aspect of the disclosure, there is provided a portable identification device comprising: a biometric recognition system arranged to receive a biometric identifier; a satellite navigation system receiver arranged to receive position data from a satellite navigation system; a transmitter for sending identification data over a wireless network; and a processor arranged to: receive a request for an identification check; receive a biometric identifier via the biometric recognition system; compare the received biometric identifier with reference biometric data; and using said transmitter, send an identification result to a remote server after completion of the identification check.

Optionally, the processor being arranged to compare the biometric identifier with reference biometric data comprises being arranged to compare the received biometric identifier with reference data stored on the device.

Optionally, the processor being arranged to compare the biometric identifier with reference biometric data comprises being arranged to send the received biometric data or related data to a remote server, which compares the received data with reference data stored at the server and which sends an identification result back to the portable identification device.

Optionally, the processor is arranged to compress the raw biometric data to a lower dimension feature set.

Optionally, compressing the raw biometric data to a lower dimension feature set comprises a hashing process such as the use of a Haar transform, image bit depth reduction, or image edge finding and feature erosion techniques.

Optionally, the biometric recognition system comprises a finger recognition system.

Optionally, the biometric recognition system comprises a fingerprint recognition system.

Optionally, the biometric recognition system comprises a detection system that provides both fingerprint detection and detection of other finger indicia.

Optionally, the portable identification device further comprises a motion sensor.

Optionally, the portable identification device comprises a casing and a tamper-proof mechanism for detecting attempts to open the casing.

Optionally, the portable identification device comprises a casing and an electrical tamper-proof mechanism arranged to detect attempts to electrically interfere with the reported position from satellite position acquisition signals.

Optionally, the portable identification device comprises an alert mechanism for alerting the user to the need to identify themselves to the device via the biometric recognition system.

Optionally, the portable identification device comprises an actuator allowing a user to contact an external party.

Optionally, the portable identification device comprises a microphone and speaker allowing said external party to communicate directly with the user via the device.

Optionally, the portable identification device comprises a screen.

Optionally, the screen comprises a monochrome screen or e-ink display.

Optionally, the portable identification device comprises a received signal strength indication monitor.

Optionally, the biometric recognition system comprises an infrared illumination source arranged to obtain an image of a finger vascular structure.

Optionally, the biometric recognition system comprises alternating sources of two different wavelengths that are arranged to carry out pulse-oximetry and/or photo-plethysmography techniques.

Optionally, the biometric recognition system comprises a system using an electrical technique with pixelated capacitative images to provide a fingerprint.

Optionally, the portable identification device is arranged to change a required digit or other biometric for identification, or to require a plurality of digits or other biometric identifiers for a successful identification.

Optionally, the biometric recognition system is arranged to recognise unique capillary patterns as blood flows.

According to a second aspect of the disclosure there is provided a wrist-watch comprising the portable identification device according to the first aspect.

According to a third aspect of the disclosure there is provided a necklace comprising the portable identification device according to the first aspect.

According to a fourth aspect of the disclosure there is provided a method of verifying the identity of a user by use of a portable identification device, comprising the steps of: receiving, via a satellite navigation system receiver, position data from a satellite navigation system; receiving, at a biometric recognition system, a request for an identification check; inputting, at the biometric recognition system, a biometric identifier; comparing the received biometric identifier with reference biometric data, and sending an identification result from the portable identification device to a remote server after completion of the identification check.

It will be appreciated that the features of the other aspects may provide or provide disclosure of corresponding steps of the method of the fourth aspect.

### BRIEF DESCRIPTION OF THE DRAWINGS

The disclosure will be described below, by way of example only, with reference to the accompanying drawings, in which:

FIG. 1 shows an overview of a system according to the disclosure;

FIG. 2 shows aspects of a biometric identification device according to one embodiment;

FIG. 3 shows aspects of a biometric identification device according to another embodiment;

FIG. 4 shows aspects of a biometric identification device according to a further embodiment; FIG. 5 shows an overview of a process according to the disclosure;

FIG. 6 shows a necklace according to the disclosure;

FIG. 7 shows a wrist-watch according to the disclosure; and

FIG. 8 shows a system diagram of a device according to an embodiment of the disclosure.

### DETAILED DESCRIPTION

We propose a device comprising a transmitter, a biometric recognition system such as a finger recognition system, an optional motion sensor and a satellite navigation receiver (including GNSS receivers such as GPS or GLONASS, or receivers for regional systems such as IRNSS) capable of tracking its own location and confirming the identity of a user by way of one or multiple biometric indicia such as fingerprints and/or finger indicia such as images of structures underlying the skin.

Additionally the device may comprise a tamper-proof mechanism for detecting attempts to open its casing. It could also detect attempts to interfere with its operation through external means such as wrapping it in a conductive material. Additionally the device may contain means of detecting attempts to electrically interfere with the reported position from GPS and other such position acquisition signals. Note, for the remainder of this document we assume that the term “GPS” and its related derivatives can includes all other similar position acquisition systems based on satellite timing data and their equivalent features. Additionally the device may comprise an alert mechanism for alerting the user to the need to identify themselves to the device via the finger recognition system.

Additionally the device may contain a battery of significant charge life capable of supporting long term GPS tracking.

Additionally the device may comprise a ‘panic button’ allowing the user to contact the providing authority's monitoring officer directly in extermis. Additionally, the device may comprise a microphone and speaker allowing said monitoring officer to communicate directly with the user via the device. Alternatively the user may be communicated with via text on a screen or an alert light such as a flashing LED, and/or a sound and/or vibration.

The device housing may advantageously not be that of a mobile phone, giving it zero resale value. A screen may be provided if desired, which may suitably be a small low-cost monochrome screen or e-ink display that may be fitted to give some indicator of functionality. There is no requirement for the device to contain a user input interface other than that required for identification. Thus, in preferred embodiments all aspects of a regular cell phone user-interface, such as keypad or touch-screen are not present in the device.

The device transmitter, or transmitters, shall be capable of connecting the device to the internet via either the mobile telephone network or via other wireless means. The device may form part of a system whereby the device's location, user identification status and device status are communicated to a remote server. The device communicates with, and can be communicated with, by the remote server over the internet.

It is intended that the monitoring of the device status can be automatic, with the provision for a remote human monitoring officer to oversee both alerts generated by the system, or to monitor the device output directly. It is intended that the majority of the communication is automatic, though provision for human intervention can be included in the system.

The motion sensor shall detect the device motion to allow transportation/movement to be monitored. The motion sensor may comprise either a multi-axis accelerometer or an accelerometer and a gyroscope combination. It is intended that the motion sensor can augment the position the device registers via the GPS system, as well as confirming that the device is in motion or at rest. The GPS receiver (GPS or assisted GPS) shall generate a position for the device. As a secondary mechanism the device location can be confirmed via the relative signal strengths from nearby mobile phone transmitters and/or other wireless networks such as wireless Local Area Network sources.

The device can also be set up to implement a geofence. If the user goes outside the boundary of a predetermined geographical area, then an alert can be generated. The device may also be useful for policing restraining orders or similar to protect victims of stalking or harassment. As an example, a user who is subject to a restraining order could have a device as described herein. The user whom the restraining order is granted in favour of could also have a device, but more preferably could have a non-invasive application or service running on their cell phone and which can interact with the system so that the relative locations of the user and the other party can be compared, and an alert generated if a predetermined distance threshold is breached.

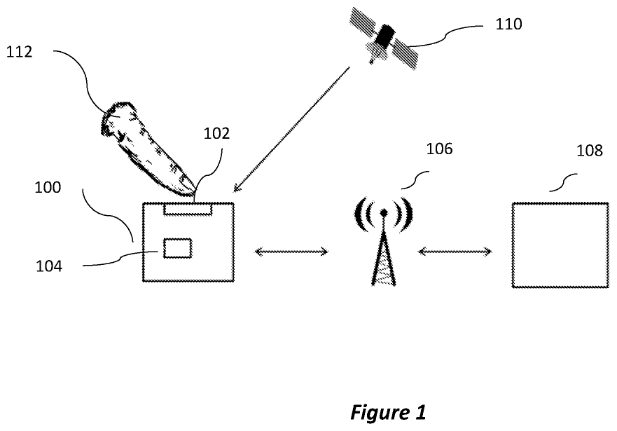

As shown in FIG. 1, the device 100 has a finger recognition device 102 such as a fingerprint reader. This is shown being suitable for receiving a finger 112, though other digits or body parts can be used with the device 100. An indicator device 104 is provided which provides a prompt for the user to provide their identity. The indicator device may suitably comprise a light emitting diode, though it could also include other indicators such as a speaker to provide an audible alert or a haptic unit to provide a vibration. The device 100 comprises a transmitter which can send data via a mobile network 106; and a satellite navigation system receiver which can receive position data from a GPS location system 110.

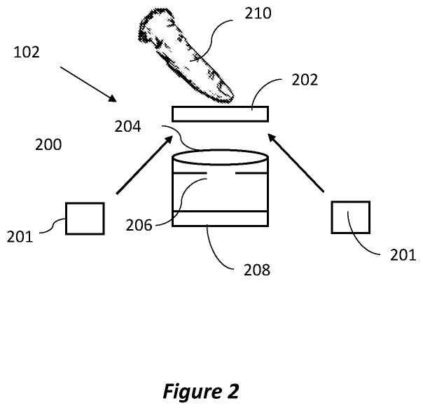

A biometric recognition device 102 can take various different forms, and these are illustrated in FIGS. 2 to 4. In FIG. 2, infrared illumination 200 from an IR source 201 is incident upon a capacitive sensor 202 realised on an infrared transmissive material to detect the surface of a fingerprint. An imager comprises a lens 204, aperture 206 and solid state (eg CMOS) image sensor 208. The imager is focused inside the finger 210 and is configured as a microscope.

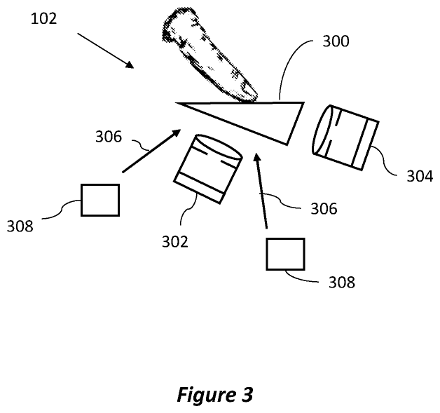

FIG. 3 shows an alternative embodiment, comprising a totally internally reflecting prism 300, a first camera 302 for imaging a subsurface capillary pattern and a second camera 304 for imaging a surface fingerprint from the frustrated total internally reflecting prism, together with IR and visible illumination 306 from a combined light source 308. The structure of the cameras 302, 304 is similar to that of the imager shown in FIG. 2.

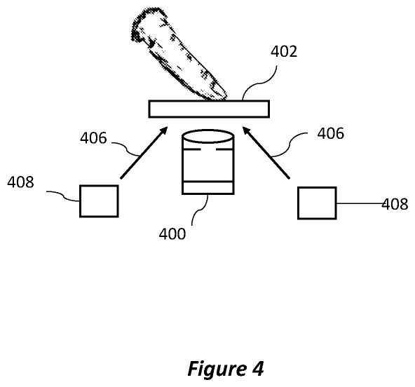

FIG. 4 shows an alternative embodiment, wherein a camera 400 is arranged to image surface features with visible illumination and subsurface capillary pattern with infrared illumination. IR and visible illumination 406 is sent from a combined light source 408. The finger is received on a glass plate 402. The combined light source (of this and other embodiments with that feature) can send time-multiplexed light signals so that one camera frame is in the visible domain and the next is in the IR domain with capillaries shown.

The illuminators above can emit radiation of any of a number of wavelengths for identification of the surface detail of the finger (i.e. what is classically regarded as a fingerprint). Additionally, infrared light (wavelength greater than 700 nm) may be used to obtain an image of the finger vascular structure. Additionally, alternating sources of two wavelengths can be used, so that a pulse for the user can be obtained using pulse-oximetry or photo-plethysmography techniques, thus confirming the finger is live. Note this function can be fulfilled using the same illumination sources as the fingerprint reader and either sensed by integrating each of a series of images to obtain the overall intensity variation over a number of frames from the imager, or by using a dedicated structure having one or more photodiodes.

Alternatively an electrical technique using pixelated capacitative images can provide a fingerprint. Additionally variations in the impedance of sub-dermal structures can be mapped to provide identification from the finger, or other specified body part.

In operation the device shall be carried by the user and at intervals the user shall be alerted to the need to identify themselves. The timing of the alert can be generated either internally to the device by means of a timing circuit or externally via a signal received by the device. The alert can take the form of a vibrator, a sound or light, or a combination thereof, or if a display is included, could be displayed. The user identifies themselves via the fingerprint reader. On obtaining a fingerprint image, a finger vascular image, a pulse oximetry reading or a plurality thereof, a pattern match can be established locally in or by the device and a verification signal can be sent to a remote server, or the raw or partially processed information can be sent to a remote server. Note the fingerprint, or vascular, image can be compressed locally to a lower dimension feature set prior to transmission if required. The generation of the lower dimension feature may take the form of a hashing process such as the use of a Haar transform or by a standard image bit depth reduction or by image edge finding and feature erosion techniques. The fingerprint and/or vascular image or the feature set generated from it/them are referred to as the identification features for ease of reading.

As the user identity needs confirmation many times the digit required for identification may change between readings or a single identification may require a number of digits to be used. The digits may be chosen at random by the user and the device can indicate whether the digits chosen are acceptable or the device can indicate to the user which digits to apply to the finger print sensor system. On requesting and receiving a positive identification the device transmits the result to a remote server. On requesting an identification event and receiving either a negative result or no-result the device sends an alert to the remote server. Additionally if the device generates a negative result the identification features are sent to the server for further analysis.

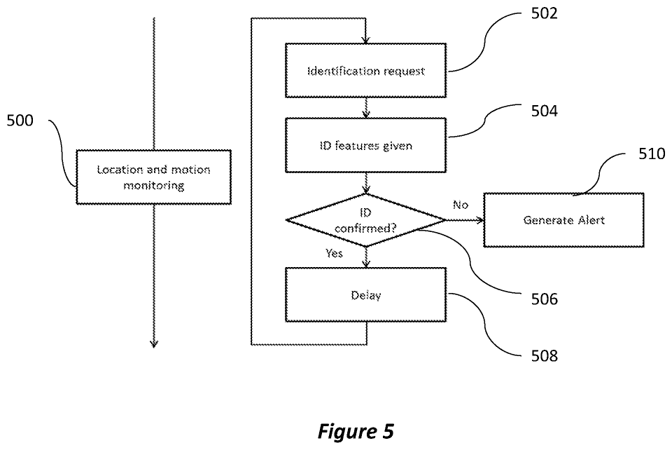

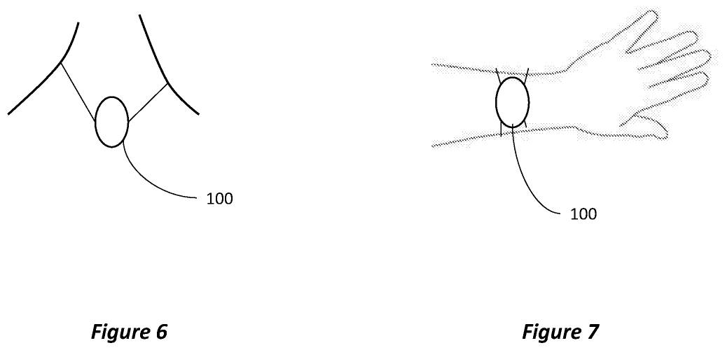

The device is not necessarily a rectangular box and the part of the body used to provide the means of identification is not necessarily a finger. Unique capillary patterns as blood flow, either sensed by optical or electrical means, can be generated by sensing other body parts, such as the wrist, forearm or neck. This allows the device to take the form of a wrist-watch (as shown in FIG. 7) or necklace (as shown in FIG. 6). Sensing directly from the skin, without the user's intervention, is possible. In the necklace and wrist watch embodiments, the functional sensor part of the device may be in contact with or in close proximity to the skin of the user, and can be overlaid with ornamental elements such as ornamentation for a necklace pendant, or the components of a regular wristwatch.

Additionally a wristband comprising the device implemented as a finger-print reader can be envisaged. A user can wear the wristband on the wrist of one arm and easily confirm their identity using their digits from the hand of their other arm.

### An Example Application Context

On receipt of a court order, or the outcome of another legal process (such as an immigration requirement), the user will have biometric data collected to yield reference biometric data, for example they may be fingerprinted using a master identification device, thus yielding a reference set of fingerprints and/or finger vascular structure images. These are held on a database and/or communicated to the identification device dedicated to the user. The user is given the identification device and a charging unit. The charging unit may comprise an RF identification which can communicate with the identification device, thus allowing confirming the location of the identification device when in-doors.

As well as use contexts relating to legal proceedings, the device can be used for other applications, such as preventing or monitoring school truancy, or caring for the elderly or those suffering from dementia.

Use of the device is shown in FIG. 5. The identification device's location, motion and tamper (i.e. attempts to interfere with its operation) status are monitored on a predetermined basis (step 500). Either the remote server or the identification device flags (step 502) to the device user interface that the user should identify themselves to the system by way of the fingerprint recognition system. The interval between flags can be set, random or pseudo-random. The user places their finger, or fingers, on the fingerprint recognition interface (step 504) and the resultant identification reading is sent to the remote server to be checked (step 506). If the identification is positive no action is taken. The process is repeated after a set delay, 508. If the result is negative from a finger reading or no finger is presented then the user is assumed to have absconded/be in breach of the legal requirement place upon them and appropriate action is taken. An identification result is generated, 510. This may be an alert (as shown) if the identification check is not successful, or a success result if the identification check is successful.

As an improvement to prevent false alerts being generated, if the result is negative but an attempt was made to read a fingerprint, then another fingerprint may be requested. This avoids an alert being generated when a user is making a genuine effort to identify themselves but makes an error, such as moving their finger or releasing it too early before a reading is completed. The number of times that a finger reading is requested can be limited to avoid abuse of this feature.

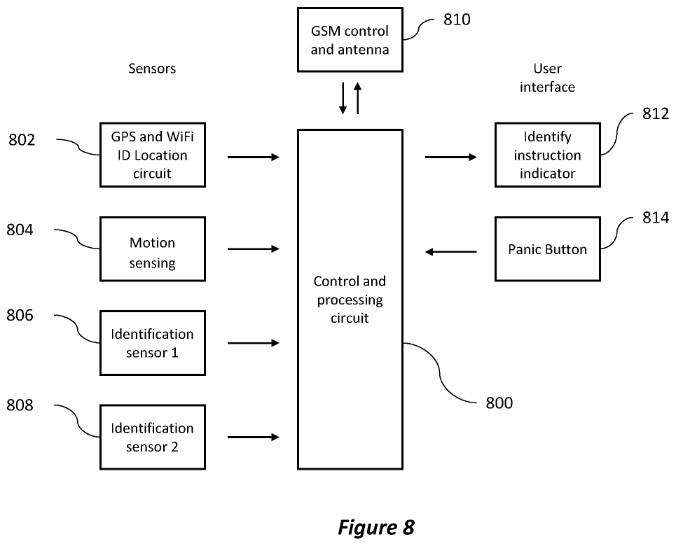

FIG. 8 shows a system diagram of a device according to an embodiment of the disclosure. A control and processing unit 800 can receive signals from sensors including a GPS and WiFi ID location circuit 802, motion sensing unit 804 and one or more identification sensors 806, 808. It also comprises a GSM control and antenna module 810 for transmitting and receiving signals over a mobile network. A user interface comprises an identify instruction indicator 812 which can be an LED or other notification mechanism as discussed elsewhere and an optional panic button 814 which can be a push button actuator as discussed elsewhere to initiate contact with an external party such as a supervising authority.

While aspects of the disclosure have been described with reference to at least one exemplary embodiment, it is to be clearly understood by those skilled in the art that the invention is not limited thereto.

1. A portable identification device comprising:
a biometric recognition system arranged to receive a biometric identifier;
a satellite navigation system receiver arranged to receive position data from a satellite navigation system;
a transmitter for sending identification data over a wireless network; and
a processor arranged to:
receive a request for an identification check;
receive a biometric identifier via the biometric recognition system;
compare the received biometric identifier with reference biometric data; and
using said transmitter, send an identification result to a remote server after completion of the identification check.

2. The portable identification device of claim 1, wherein the processor being arranged to compare the biometric identifier with reference biometric data comprises being arranged to compare the received biometric identifier with reference data stored on the device.

3. The portable identification device of claim 1, wherein the processor being arranged to compare the biometric identifier with reference biometric data comprises being arranged to send the received biometric data or related data to a remote server, which compares the received data with reference data stored at the server and which sends an identification result back to the portable identification device.

4. The portable identification device of claim 3, wherein the processor is arranged to compress the raw biometric data to a lower dimension feature set, and optionally wherein compressing the raw biometric data to a lower dimension feature set comprises a hashing process such as the use of a Haar transform, image bit depth reduction, or image edge finding and feature erosion techniques.

5. (canceled)

6. The portable identification device of claim 1, wherein the biometric recognition system comprises at least one of a finger recognition system and a fingerprint recognition system.

7. (canceled)

8. The portable identification device of claim 1, wherein the biometric recognition system comprises a detection system that provides both fingerprint detection and detection of other finger indicia.

9. The portable identification device of claim 1, further comprising a motion sensor.

10. The portable identification device of claim 1, comprising a casing and a tamper-proof mechanism for detecting attempts to open the casing.

11. The portable identification device of claim 1, comprising a casing and an electrical tamper-proof mechanism arranged to detect attempts to electrically interfere with the reported position from satellite position acquisition signals.

12. The portable identification device of claim 1, comprising an alert mechanism for alerting the user to the need to identify themselves to the device via the biometric recognition system.

13. The portable identification device of claim 1, comprising an actuator allowing a user to contact an external party.

14. The portable identification device of claim 11, comprising a microphone and speaker allowing said external party to communicate directly with the user via the device.

15. The portable identification device of claim 1, comprising a screen, wherein the screen comprises a monochrome screen or e-ink display.

16. (canceled)

17. The portable identification device of claim 1, comprising a received signal strength indication monitor.

18. The portable identification device of claim 1, wherein the biometric recognition system comprises an infrared illumination source arranged to obtain an image of a finger vascular structure, and/or wherein the biometric recognition system comprises alternating sources of two different wavelengths that are arranged to carry out pulse-oximetry and/or photo-plethysmography techniques.

19. (canceled)

20. The portable identification device of claim 1, wherein the biometric recognition system comprises a system using an electrical technique with pixelated capacitative images to provide a fingerprint, and/or wherein the biometric recognition system is arranged to recognise unique capillary patterns as blood flow.

21. The portable identification device of claim 1, arranged to change a required digit or other biometric for identification, or to require a plurality of digits or other biometric identifiers for a successful identification.

22. (canceled)

23. A wrist-watch comprising the portable identification device according to claim 1.

24. A necklace comprising the portable identification device according to claim 1.

25. A method of verifying the identity of a user by use of a portable identification device, comprising the steps of:
receiving, via a satellite navigation system receiver, position data from a satellite navigation system;
receiving, at a biometric recognition system, a request for an identification check;
inputting, at the biometric recognition system, a biometric identifier;
comparing the received biometric identifier with reference biometric data, and
sending an identification result from the portable identification device to a remote server after completion of the identification check.
